(19) United States
(12) Patent Application Publication
(10) Pub. No.: US 2002/0133398 A1
(43) Pub. Date: Sep. 19, 2002

(54) System and method for delivering media

(75) Inventors: Alan S. Geller, Redmond, WA (US); Jeffrey C. Beman, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 09/773,449

(22) Filed: Jan. 31, 2001

(51) Int. Cl. G06F 17/60

(52) U.S. Cl. 705/14; 705/10

(57) ABSTRACT

A system and method for delivering advertisement media are provided. Each advertisement media is associated with an advertisement delivery campaign specifying an impression goal and a campaign date range. Utilizing a dynamic array representative of the campaign date range, an initial rotation frequency is calculated based on a predicted number of page views that will be encountered during the advertisement media campaign. As the campaign progresses, the predicted number of page views in each array element is replaced by the actual number of page views encountered. Accordingly, the rotation frequency will fluctuate with the number of actual page views encountered. An advertisement delivery engine utilizes the dynamic rotation frequency to select an appropriate advertisement for each advertisement request.

### FIELD OF THE INVENTION

In general, the present invention relates to computer software, and in particular, to a system and method for dynamically distributing advertisement media for display.

### BACKGROUND OF THE INVENTION

The ability for advertisers to place and track advertisements on software applications running on a consumer's personal computer creates revenue generating streams for an advertisement generating service. In a conventional advertisement delivery format, the advertisement generating service obtains requests for advertisement media and returns corresponding advertisement media via a network connection, such as the Internet. In turn, the advertisement generating service establishes agreements with various advertisement media providers in which the advertisement generating service is obligated to deliver the media a certain number of times over a given period of time. The advertisement generating service's obligation is often referred to as an impression goal or delivery goal.

The ability for advertisement generating services to meet a delivery goal is critical to generating revenue and to complying with the terms of advertisement generating agreements. In one conventional advertisement delivery methodology, the advertisement generating service establishes a smooth delivery approach to distributing a required number of media displays over the given time period of the advertisement media delivery campaign. Generally described, a smooth delivery approach dictates that an equal number of advertisement media is to be delivered for each day within an advertisement delivery campaign. Thus, the advertisement generating service calculates a daily impression goal by dividing the total number of desired impressions by the total number of days in the advertisement delivery campaign. FIG. 1 is a line plot 70 illustrative of a smooth delivery goal for an illustrative media campaign lasting 21 days and having an impression goal of 42,000,000 media deliveries. Accordingly, under the smooth delivery approach, and as illustrated in FIG. 1, each day 72 has a daily impression goal of 2,000,000 media deliveries.

One skilled in the relevant art will appreciate that the number of media display opportunities encountered by an advertisement generating service may vary for a variety of reasons. Generally described, media display opportunities are generated when a set of criteria, such a user entered search terms and/or user demographics, matches criteria submitted by the advertisement media provider. In some instances, the number of media display opportunities encountered during a weekend is much less than the number of media display opportunities encountered during the week. Additionally, in some instances, the number of display opportunities encountered on one particular weekday (e.g., Monday) is greater than the number of display opportunities encountered during another particular weekday (e.g., Friday).

FIG. 2 is a line plot 74 illustrating the number of media display opportunities encountered per day during the 21 day media delivery campaign 76 in comparison to the a smooth delivery target goal of 2,000,000 displays. One skilled in the relevant art will appreciate that if the number of display opportunities each day exceeds the daily impression goal, the advertisement generating service can meet its obligation utilizing a smooth delivery approach. However, as illustrated in FIG. 2, if the number of media display opportunities encountered during a particular day is less than the daily impression goal, the advertisement generating service cannot meet its daily impression goal for those particular days and is threatened with failing to meet its overall impression goal. The failure to meet a daily impression goal is generally referred to as under-delivery.

In an attempt to overcome under-delivery deficiency, some advertisement generating services utilizing smooth advertisement delivery, attempt to make up for any deficiencies caused by lower media display opportunities by delivering more media during those days in which the media display opportunities exceed the daily impression goal. This embodiment is generally referred to as over-delivery. FIG. 3 is a line plot 78 illustrative of a smooth delivery advertisement delivery campaign 80 in which additional advertisement media opportunities are utilized to make up for deficiencies associated with under delivery. As illustrated at 82, the advertisement generating service utilizes all the display opportunities following two consecutive under-delivery days to make up for the deficiency. Additionally, as illustrated at 84, the advertisement generating service must also utilize additional portion of the next days media display opportunities to continue to make up for the deficiency.

Advertisement generating services attempting to over deliver advertisement media to compensate for lower display opportunities are deficient for a number of reasons. In one aspect, over delivering media reduces the amount of media display opportunities available to other media display campaigns. With reference to FIG. 3, a second advertisement media campaign would be unable to meet its goals for any days in which the illustrated media campaign over consumed all the display opportunities. In another aspect, over-delivery of media can be further deficient in the event that the media campaign terminates on a day in which there was an under delivery. For example, if a media campaign terminates on a Sunday in which the number of media display opportunities is below the daily impression goal, the advertisement media campaign is at risk of violating its agreement with advertisement media provider.

Thus, there is a need for a system and method for dynamically managing media display campaigns to accommodate for fluctuations in media display opportunities.

### SUMMARY OF THE INVENTION

A system and method for delivering advertisement media are provided. Each advertisement media is associated with an advertisement delivery campaign specifying an impression goal and a campaign date range. Utilizing a dynamic array representative of the campaign date range, an initial rotation frequency is calculated based on a predicted number of page views that will be encountered during the advertisement media campaign. As the campaign progresses, the predicted number of page views in each array element is replaced by the actual number of page views encountered. Accordingly, the rotation frequency will fluctuate with the number of actual page views encountered. An advertisement delivery engine utilizes the dynamic rotation frequency to select an appropriate advertisement for each advertisement request.

In accordance with an aspect of the present invention, a method for managing media delivery is provided. A media delivery service obtains a request for media. The media delivery service determines one or more media to deliver in response to the request utilizing a dynamic rotation frequency. The media delivery service then outputs the one or more media.

In another aspect of the present invention, an advertisement media delivery system is provided. The advertisement media delivery system includes an advertisement media manager operable to generate new advertisement media campaigns. The advertisement media delivery system also includes an advertisement media engine operable to generate an advertisement media schedule including a dynamic rotation frequency based on information obtained from the advertisement media manager. The advertisement media engine also is operable to deliver one or more advertisement media based on the advertisement media schedule obtained from the advertisement media scheduler.

In a further aspect of the present invention, a method for tracking media display opportunities in a dynamic array having a number of array elements is provided. A media delivery service obtains a media delivery campaign including a media delivery goal, a target market segment, and data indicative of a time period for generating the delivery goal. The media delivery service selects a number of array elements for the dynamic array such that the array elements correspond to a fixed time period. Furthermore, the sum of the array element time periods equals the time period for generating the delivery goal. The media delivery service populates each array element with an estimated number of display opportunities for the time period represented by the array element. The media delivery service then dynamically replaces the estimated number of display opportunities with an actual number of media display opportunities encountered.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a line plot illustrative of a smooth delivery daily impression goal for an advertisement generating service implementing an advertisement media campaign;

FIG. 2 is a line plot illustrative of a number of media display opportunities encountered during an advertisement media campaign in comparison to a smooth delivery daily impression goal;

FIG. 3 is a line plot illustrative of an over-delivery of advertisement media by an advertisement generating service in comparison with a number of media display opportunities encountered during an advertisement campaign;

FIG. 4 is a block diagram illustrative of an advertisement generating system for dynamically delivering advertisement media in accordance with the present invention;

FIG. 5 is a block diagram illustrative of a dynamic array for managing media display opportunities for an advertisement media campaign in accordance with the present invention;

FIG. 6 is the dynamic array of FIG. 6 illustrating the replacing of array elements with actual display opportunities encountered during the advertisement media campaign in accordance with the present invention;

FIG. 7 is a line plot illustrative of the delivery of media according to a dynamic rotation frequency in comparison with a number of media display opportunities encountered during an advertisement campaign; and

FIG. 8 is a block diagram of a computer system suitable for use with the present invention.

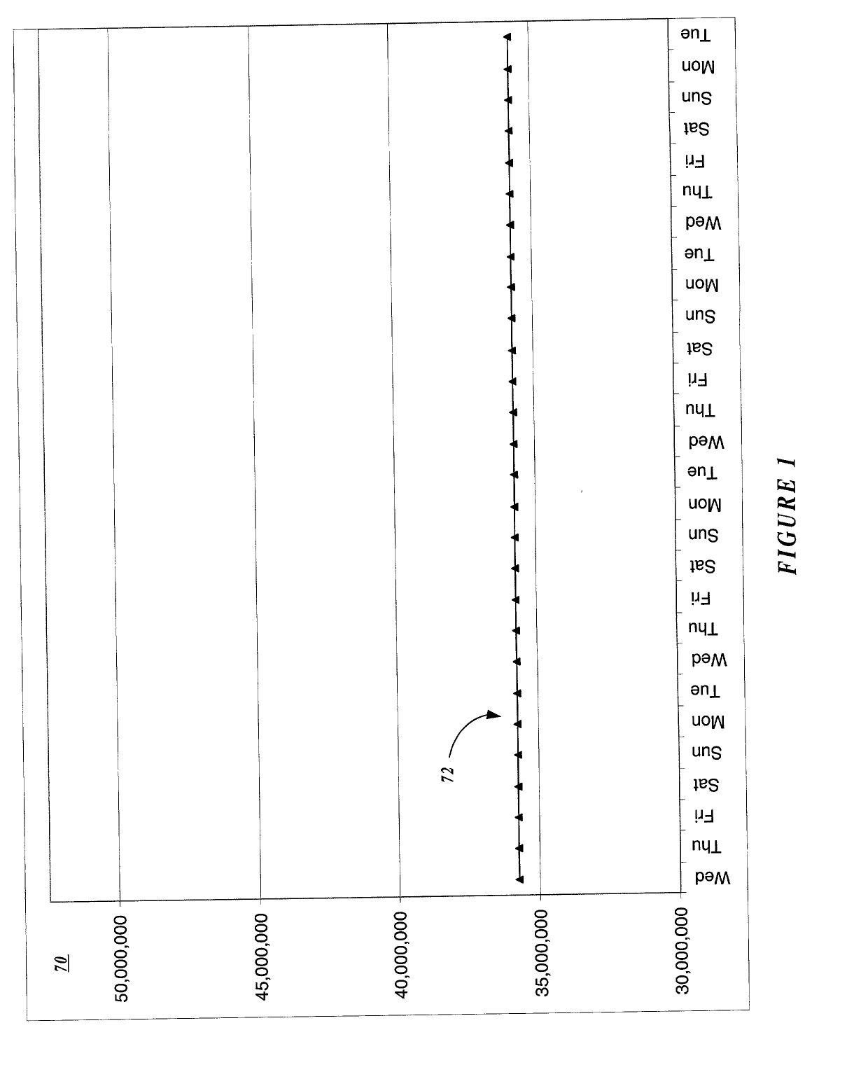

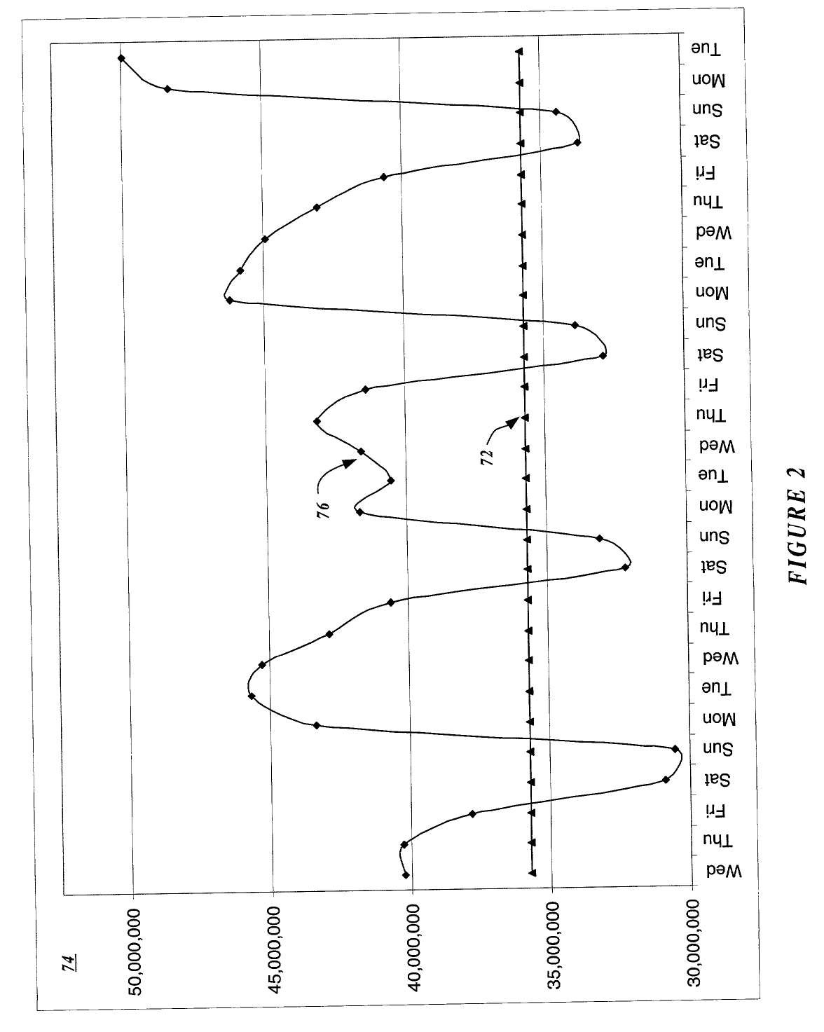

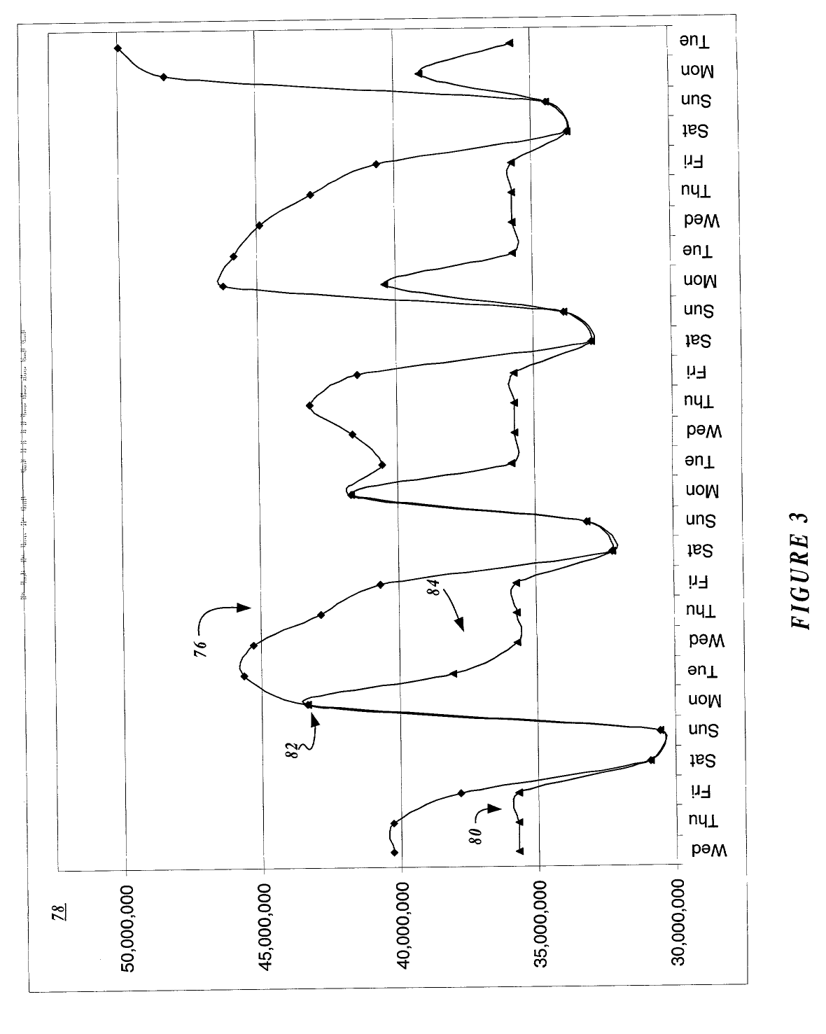

### DETAILED DESCRIPTION OF THE PREFERRED EMBODIMENT

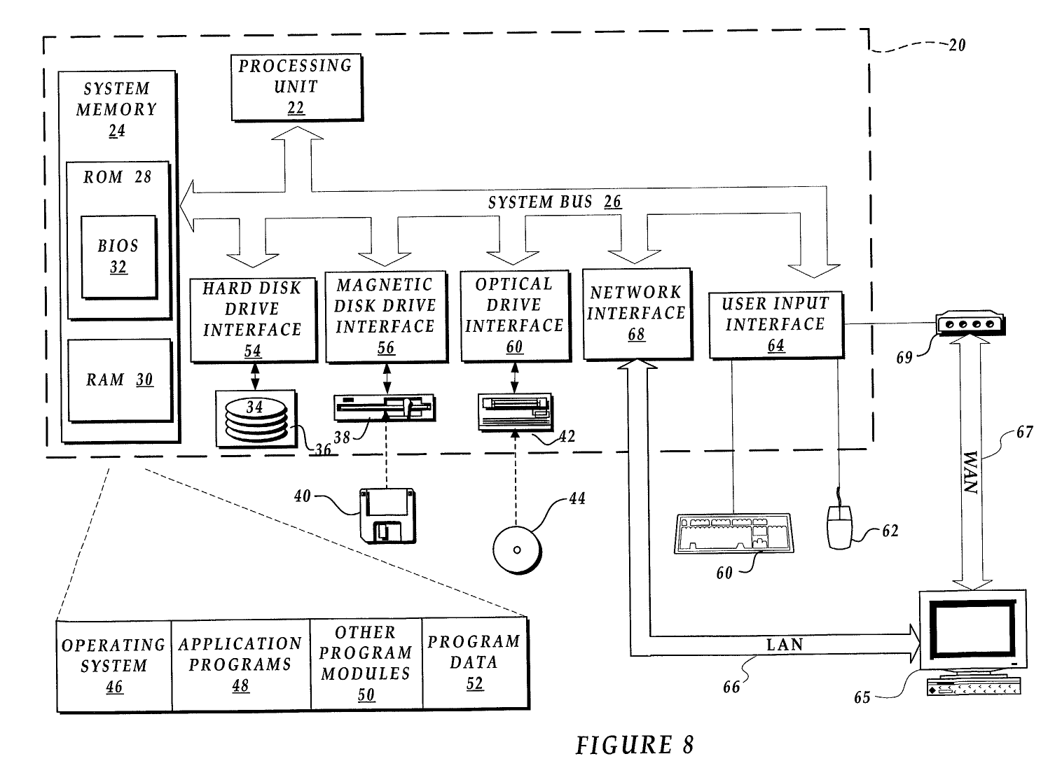

FIG. 8 illustrates an example of a suitable computing system environment in which the invention may be implemented. The computing system environment is only one example of a suitable computing environment and is not intended to suggest any limitation as to the scope of use or functionality of the invention. Neither should the computing environment be interpreted as having any dependency requirement relating to any one or combination of components illustrated in the exemplary operating environment.

The invention is operational in numerous other general purpose or special computing system environments or configurations. Example of well known computing systems, environments, and/or configurations that may be suitable for implementing the invention include, but are not limited to, personal computers, server computers, laptop devices, multiprocessor systems, and microprocessor-based systems, network PCs, minicomputers, mainframe computers, distributed computing environments that include any of the above systems, or the like.

The invention may be described in the general context of computer-executable instructions, such as program modules, being executed by a computer. Generally, program modules include routines, programs, objects, components, data structures, etc. that perform a particular task or implement particular abstract data types. The invention may be also practiced in distributed computing environments where tasks are performed by remote processing devices that are linked through a communications network. In a distributed computing environment, program modules may be located in both local and remote computer storage media, including memory storage devices.

With reference to FIG. 8, an exemplary system for implementing the invention includes a general purpose-computing device in the form of a computer 20. Components of a computer 20 include, but are not limited to, a processing unit 22, a system memory 24, and a system bus 26 that couples various system components, including the system memory, to the processor. The system bus may be any of several types of bus structures including a memory bus or memory controller, peripheral bus, and a local bus using any of a variety of bus architectures. By way of example, not limitation, such architectures include Industry Standard Architecture (ISA) normal capitalization bus, Micro Channel Architecture (MCA) bus, Enhanced ISA (EISA) bus, Video Electronics Standards Association (VESA) local bus, and Peripheral Component Interconnect (PCI) bus also known as a Mezzanine bus.

The computer 20 typically includes a variety of computer-readable media. Computer-readable media can be any available media that can be accessed by the computer 20 and includes both volatile and non-volatile media, removable and non-removable media. By way of example, and not limitation, computer-readable media may comprise computer storage media and communication media. Computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store the desired information and which can be accessed by the computer 20.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner to encode information in the signal. By way of example, and not limitation, communication media includes wired media such as a wired network or direct wired connection, and wireless media such as acoustic, RF, infrared, and other wireless media. Combinations of any of the above should also be included within the scope of computer-readable media.

The system memory 24 includes computer storage media in the form of volatile and/or non-volatile memory such as read only memory (ROM) 28 and random access memory (RAM) 30. A basic input/output system 32 (BIOS), containing the basic routines that help to transfer information between elements within the computer 20, such as during start-up, is typically stored in ROM 28. RAM 30 typically contains data and/or program modules that are immediately accessible to and/or presently being operated on by the processing unit 22. By way of example, and not limitation, FIG. 8 illustrates an operating system 46, application programs 48, other program modules 50, and program data 52.

The computer 20 may also include removable/non-removable, volatile/non-volatile computer storage media. By way of example only, FIG. 8 illustrates a hard disk drive 36 that reads from or writes to non-removable, non-volatile magnetic media 38, a magnetic drive 38 that reads from or writes to a removable, non-volatile magnetic disk 40, and an optical disk drive 42 that reads from or writes to a removable, non-volatile optical disk 44, such as CD-ROM or other optical media. Other removable/non-removable, volatile/non-volatile computer storage media that can be used in the exemplary operating environment include, but are not limited to, magnetic tape cassettes, flash memory cards, DVD, digital video tape, Bernoulli cap cartridges, solid state RAM, solid state ROM, and the like. The hard disk drive 34, magnetic disk drive 38, and optical disk drive 42 may be connected to the system bus 26 by a hard disk drive interface 54, a magnetic disk drive interface 56, and an optical drive interface 58, respectively. Alternatively, the hard disk drive 34, magnetic disk drive 38, and optical disk drive 42 are typically connected to the system bus 26 by a Small Computer System Interface (SCSI).

The drives and their associated computer storage media discussed above and illustrated in FIG. 8, provide storage of computer-readable instructions, data structures, program modules, and other data for the computer 20. In FIG. 8, for example, the hard disk drive 34 is illustrated as storing the operating system 46, application programs 48, other programs 50, and program data 52. Note that these components can either be the same as or different from the operating system 46, the other program modules 50, and the program data 52. A user may enter commands and information into the computer 20 through input devices such as a keyboard 60 and a pointing device 62, commonly referred to as a mouse, track ball, or touch pad. Other input devices (not shown) may include a microphone, a joystick, a game pad, a satellite dish, a scanner, or the like. These and other input devices are often connected to the processing unit 22 through user input interface 64 and may be connected by other interface and bus structures, such as a parallel port, game port, or other universal serial bus (USB).

The computer 20 may operate in a network environment using logical connections to one or more remote computers 65. The remote computer 65 may be a personal computer, a server, a router, a network PC, a peer device, or other common network node, and typically includes many or all of the elements described above relative to the computer 20, although only a memory storage device has been illustrated in FIG. 8. The logical connections depicted in FIG. 8 include a local area network (LAN) 66 and a wide area network (WAN) 67, but also include other networks. Such network environments are commonplace in office, enterprise-wide computer networks, intranets, and the Internet. It will be appreciated by one skilled in the relevant art that the computer 20 may be configured such that at least one network connection is non-continuous. Accordingly, the computer 20 would be unable to communicate with the remote computer 65 throughout a period of time that the network connection is disabled. Such a configuration is described generally as an “off-line” configuration.

When used in a LAN network environment, the computer 20 is connected to the LAN 66 through a network interface adapter 68. When used in a WAN network environment, the computer typically includes a modem or other means for establishing communications over the WAN 68, such as the Internet. The modem, which may be internal or external, may be connected to the system bus 26 via the serial port interface or other appropriate mechanism. In a networked environment, program modules depicted relative to the computer 20, or portions thereof, may be stored in the remote memory storage device. By way of example, and not limitation, FIG. 8 illustrates remote application programs 48 as residing on memory device 24. It will be appreciated that the network connections shown are exemplary and other means of establishing communication between the computers may be used. Although many other internal components of the computer 20 are not shown, those of ordinary skill will appreciate that such components and their interconnection are well known. Accordingly, additional details concerning the internal construction of the computer 20 need not be disclosed in connection with the present invention.

Those skilled in the art will understand that program modules such as the operating system 46, the application programs 48, and data 52 are provided to the computer 20 via one of its memory storage devices, which may include ROM 28, RAM 30, hard disk drive 34, magnetic disk drive 38, or optical disk device 42. The hard disk drive 34 is used to store data 52 and the programs, including the operating system 46 and application programs 48.

When the computer 20 is turned on or reset, the BIOS 32, which is stored in ROM instructs the processing unit 22 to load the operating system from the hard disk drive 34 into the RAM 30. Once the operating system 46 is loaded into RAM 30, the processing unit executes the operating system code and causes the visual elements associated with the user interface of the operating system to be displayed on the monitor 61. When an application program 48 is opened by a user, the program code and relevant data are read from the hard disk drive and stored in RAM 38.

As is appreciated by those skilled in the art, the World Wide Web (WWW) is a vast collection of interconnected or “hypertext” documents written in HyperText Markup Language (HTML) or other markup languages, that are electronically stored at WWW sites throughout the Internet. A WWW site is a server connected to the Internet that has mass storage facilities for storing hypertext documents and that runs administrative software for handling requests for those stored hypertext documents. A hypertext document normally includes a number of hyperlinks that may be identified in various ways (e.g., highlighted portions of text) which link the document to other hypertext documents possibly stored at a WWW site elsewhere on the Internet. Each hyperlink is associated with a Uniform Resource Locator (URL) and provides the exact location of the linked document on a server connected to the Internet and describes the document. Thus, whenever a hypertext document is retrieved from any WWW server, the document is considered to be retrieved from the WWW. As is known to those skilled in the art, a WWW server may also include facilities for storing and transmitting application programs, which are application programs written in the JAVA™ programming language from Sun Microsystems, for execution on a remote computer. Likewise a WWW server may also include facilities for executing scripts or other application programs on the WWW server itself.

A consumer or other remote user may retrieve hypertext documents from the WWW via a WWW browser application program. The WWW browser is a software application program for providing a graphical user interface to the WWW. Upon request from the consumer via the WWW browser, the browser accesses and retrieves the desired hypertext document from the appropriate WWW server using the URL for the document and a protocol known as a HyperText Transfer Protocol (HTTP). HTTP is a higher-level protocol than TCP/IP and is designed specifically for the requirements of the WWW. It is used on top of TCP/IP to transfer hypertext documents between servers and clients. The WWW browser may also retrieve application programs from the WWW server, such as JAVA™ applets, for execution on the client computer.

The present application relates to a system and method for dynamically managing the delivering of media. Specifically, the present invention will be described in relation to a system and method for dynamically managing advertisement media delivered during an advertisement media campaign. As will be readily understood by one skilled in the relevant art, the present invention is not limited in its application to an advertisement media delivery system. Thus, it is to be understood that the disclosed embodiment is only by way of example and should not be construed as limiting.

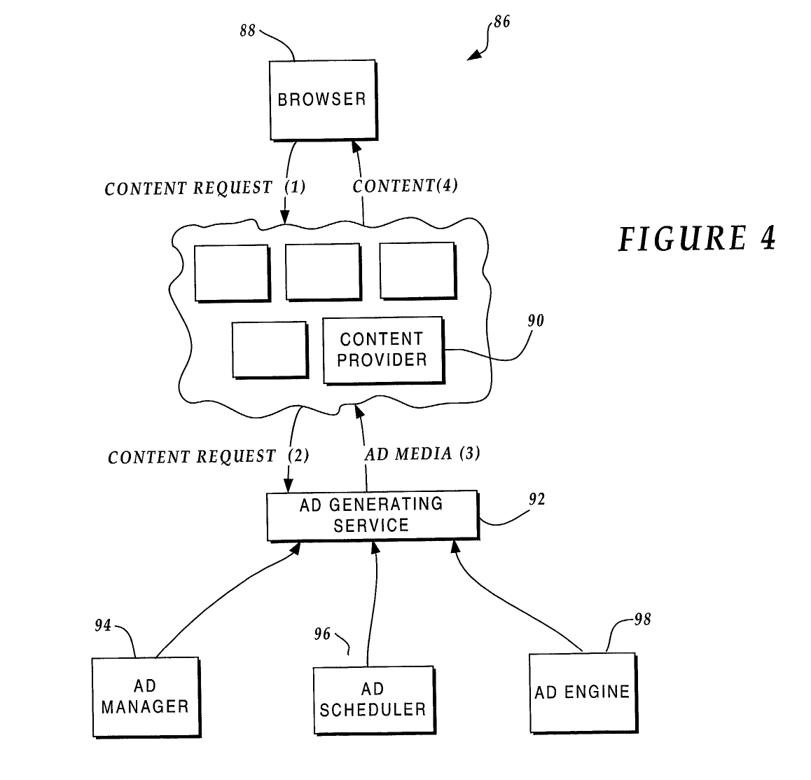

FIG. 4 is a block diagram illustrative of an advertisement media delivery system 86 for managing advertisement media in accordance with the present invention. In an illustrative embodiment, the advertisement media delivery system 86 includes a browser computer 88, which generates content requests to a content provider 90. The content provider obtains the browser computer request and user demographic information to select the content to display. In addition to returning requested content, in the illustrative embodiment, the content provider 90 also returns one or more advertising media to the browser computer 88.

In an actual embodiment of the present invention, the content provider 90 does not generate nor select the advertisement media to be displayed by the browser computer 88. Instead, the content provider requests advertisement media corresponding to the browser computer request and user demographics from an advertisement generating service 92. The advertisement generating service includes an advertisement manager 94 for obtaining advertisement media from various advertisement media providers, an advertisement scheduler 96 for encapsulating advertisement media delivery campaign information and an advertisement engine 98 for selecting and delivering the selected media to the content provider 90.

One skilled in the relevant art will appreciate that alternative advertisement generating service configurations may be practiced with the present invention. Additionally, one skilled in the relevant art will appreciate that the advertisement generating service may directly supply the advertisement media to the browser computer 88.

In an actual embodiment of the present invention, the advertisement engine 98 selects which advertisement media to deliver by calculating a rotation frequency for each advertisement media. The advertisement engine then utilizes the rotation frequency to calculate an advertisement priority score. In an illustrative embodiment, each advertisement media is given a score ranging from 0 to 100 in which 0 is a low priority score and 100 is the highest priority score. Accordingly, the advertisement engine utilizes the priority score to select advertisement media. One skilled in the relevant art will understand that any one of a variety of scoring methods may also be practiced with the present invention.

In accordance with the present invention, rotation frequency can be defined in terms of the quotient between an impression goal and the number of advertisement media display opportunities encountered during an advertisement delivery campaign. The number of media display opportunities will be referred to as page views. Specifically, the number of media display opportunities encountered during an advertisement campaign can be further defined as the sum of the number of actual media display opportunities encountered and the number of media display opportunities predicated for the remaining portion of the advertisement campaign. Equation (1) illustrates the calculation of a rotation frequency as follows:

$$Rotation Frequency = \frac{Impression goal}{Page {Views}_{remaining} + Page {Views}_{actual}} \qquad ( 1 )$$

One skilled in the relevant art will appreciate that at the beginning of an advertisement media campaign, the number of actual page views will be zero. Thus, the rotation frequency will be the quotient of the impression goal for the campaign and an estimated number of page views for the advertisement media campaign. In an illustrative embodiment of the present invention, the estimated number of page views may be based upon previous advertisement campaigns for a particular market segment or may be based upon a default value. For example, assume a media campaign has an impression goal of 1000 impressions over a campaign of 28 days. If the predicted number of page views for the 28 days is 1125 page views, equation (2) illustrates the calculation of the rotation frequency at the beginning of the advertisement media campaign as follows:

$$Rotation Frequency = \frac{Impression goal of 1000}{1125 Page {Views}_{remaining} + 0 Page {Views}_{actual}} = 0.8888889 \qquad ( 2 )$$

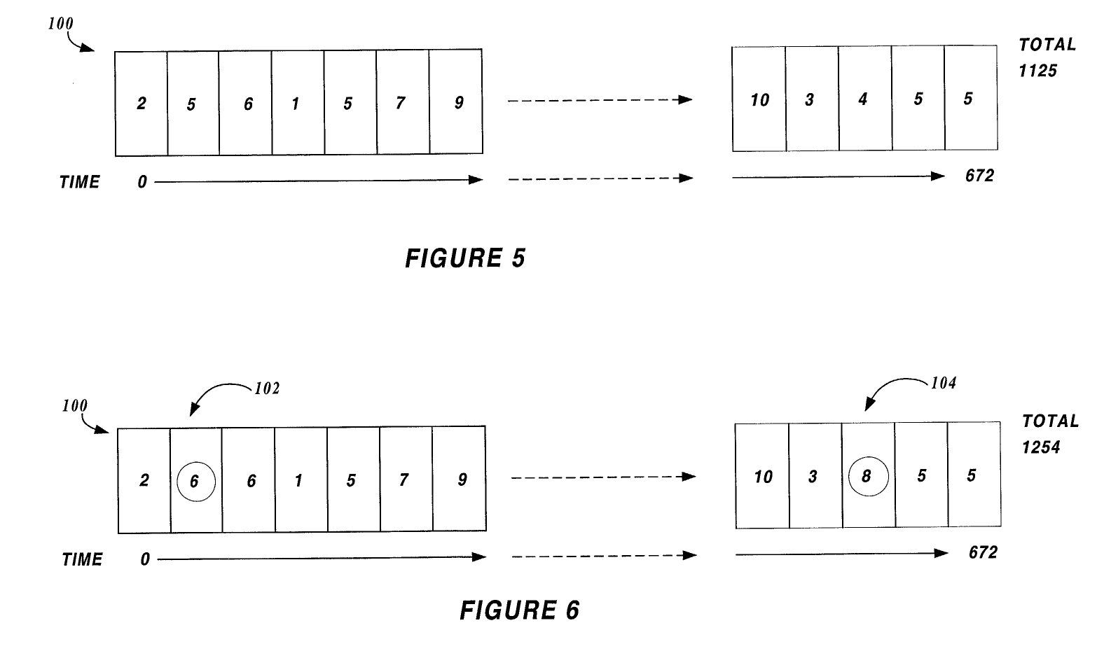

In an actual embodiment of the present invention, a dynamic array is utilized to manage the number of page views found in an advertisement campaign. FIG. 5 is a block diagram illustrative of a dynamic array 100 for managing page view data in accordance with the present invention. Each array element in the array 100 represents a fixed period of time. In an actual embodiment of the present invention, each array element is equal and the sum total time represented by array elements is equal to the total time allotted for the advertisement media campaign. With reference to the above example, if each array element represents a one-hour time period, the array 100 would contain 672 array elements. One skilled in the relevant art will appreciate that the granularity of the rotation frequency can be adjusted with more or less array elements.

At the beginning of an advertisement media campaign, each array element is populated with an estimated number of page views for the respective time period. As the advertisement campaign progresses, the advertisement engine 88 replaces the predicated number of page views with the actual number of page views encountered. Accordingly, the number of page views in the advertisement media campaign dynamically varies with the updating of the array elements. In an actual embodiment, the array elements may be updated as the data collection for each array element is complete, or multiple array elements may be updated at specific intervals.

With continued reference to the above example, assume that after 19 days in the advertisement campaign, the number of actual page views encountered during the first 19 days is 892 page view and that the remaining number of page views predicted is 362 page views. The sum total of page views would be 1254 page views, which is greater than the number originally predicted at the beginning of the advertisement media campaign. FIG. 6 is a block diagram of the array of FIG. 5 illustrating the updating of array elements at 102 and 104. As illustrated in equation (3), the new rotation frequency would be lower to compensate for the higher number of page views encountered. Thus, the advertisement engine 88 would adjust the advertisement media priority to adjust for the lower rotation frequency.

$$Rotation Frequency = \frac{Impression goal of 1000}{362 Page {Views}_{remaining} + 892 Page {Views}_{actual}} = 0.7974482 \qquad ( 3 )$$

With continued reference to the above reference, assume that after 25 days, the number of page views encountered was 917 page views and that the remaining number of page views predicted is 131 page views. The sum total of page views would be 1038, which is less than the number of page views originally predicted at the beginning of the advertisement campaign. As illustrated in equation (4), the rotation frequency would be higher to compensate for the lower number of page views encountered. Thus, the advertisement engine 88 would again adjust the advertisement media priority to reflect the higher rotation frequency.

$$Rotation Frequency = \frac{Impression goal of 1000}{131 Page {Views}_{remaining} + 917 Page {Views}_{actual}} = 0.9633911 \qquad ( 4 )$$

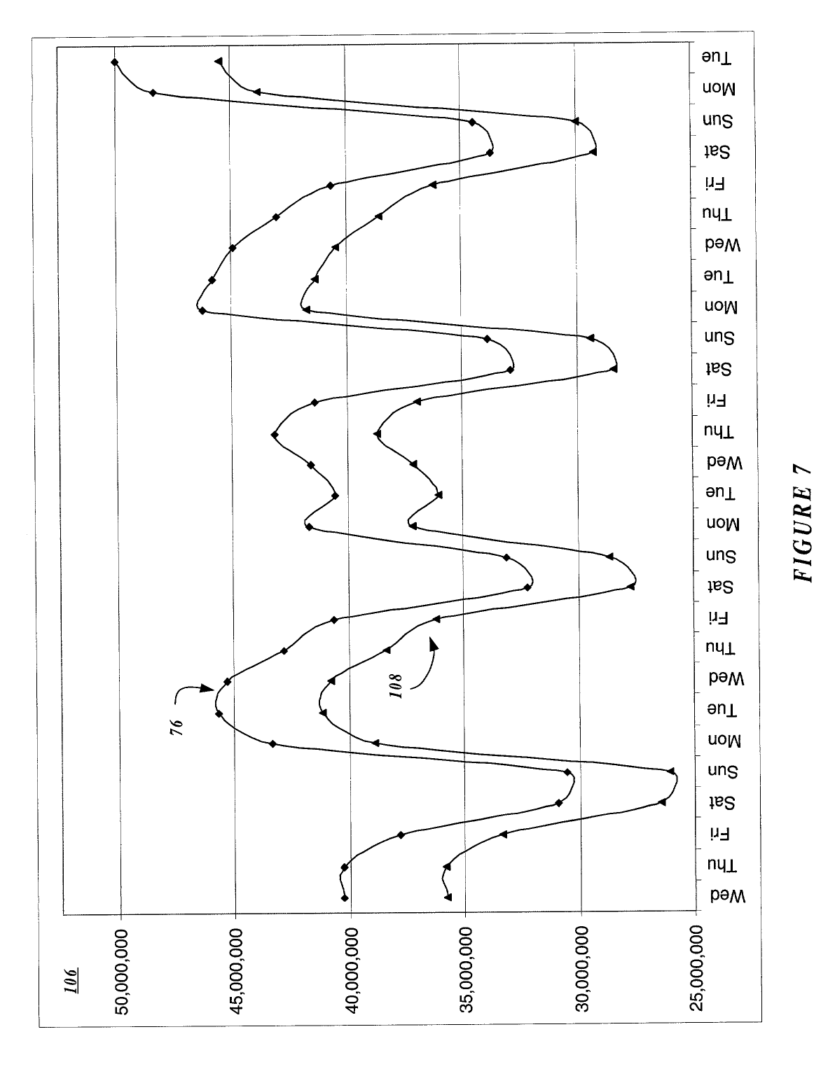

One skilled in the relevant art will appreciate that the dynamic nature of the array allows the advertisement engine 98 to compensate for fluctuations in the number of page views encountered, by adjusting the rotation frequencies for various advertisement campaigns. FIG. 7 is a line plot 106 illustrative of the number of page views encountered during an advertising campaign 108 and the adjusted number of page views utilized to meet the impression goal of the advertisement campaign 110. As illustrated in FIG. 7, the delivery of the advertisement media is not based on a static precalculated daily impression goal, but a dynamically adjusted rotation frequency.

While an illustrative embodiment of the invention has been illustrated and described, it will be appreciated that various changes can be made therein without departing from the spirit and scope of the invention.

The embodiments of the invention in which an exclusive property or privilege is claimed are defined as follows:

1. A method for managing media delivery, the method comprising:
obtaining a request for media;
determining one or more media to deliver in response to the request, wherein the determination of the one or more media corresponds to a dynamic rotation frequency; and
outputting the one or more media.

2. The method as recited in claim 1, wherein the rotation frequency is based upon a quotient of a delivery goal and a dynamic count of media display opportunities encountered during a media delivery campaign.

3. The method as recited in claim 2 further comprising initializing the rotation frequency as a quotient of the delivery goal and an estimated number of display opportunities that will be encountered during the media delivery campaign.

4. The method as recited in claim 3, wherein the rotation frequency is dynamically adjusted as a function of the number of actual display opportunities encountered during the media delivery campaign.

5. The method as recited in claim 4, wherein the rotation frequency is based on upon a quotient of the delivery goal and a sum of the number of display opportunities encountered and an estimated number of display opportunities to be encountered for any remaining time in the media delivery campaign.

6. The method as recited in claim 5, wherein the sum of the number of display opportunities and the estimated number of display opportunities remaining is embodied in a dynamic array having a number of array elements representative of fixed periods of time, wherein the sum of time represented by the array elements is equal to the a total time period allotted for the media delivery campaign.

7. The method as recited in claim 6, wherein each array element is initially populated with an estimated number of display opportunities to be encountered and wherein the contents of each array element is subsequently replaced with an actual number of display opportunities encountered during the media delivery campaign.

8. The method as recited in claim 1, wherein the media is advertising media to be delivered during an advertisement delivery campaign.

9. A computer-readable medium having computer-executable instructions for performing the method recited in any one of claims 1-8.

10. A computer system having a processor, a memory, and an operating environment, the computer system operable for performing the method recited in any one of claims 1-8.

11. An advertisement media delivery system, the system comprising:
an advertisement media manager operable to generate new advertisement media campaigns;
an advertisement media engine operable to generate an advertisement media schedule, wherein the advertisement media schedule includes a dynamic rotation frequency based on information obtained from the advertisement media manager, and wherein the advertisement media engine is operable to deliver one or more advertisement media based on the advertisement media schedule obtained from the advertisement media scheduler.

12. The advertisement media delivery system as recited in claim 11, wherein the advertisement media campaign includes information specifying a date range, a delivery goal, and a target market segment.

13. The advertisement media delivery system as recited in claim 12, wherein the dynamic rotation frequency in the advertisement media schedule is based upon the quotient of the delivery goal and a dynamic count of media delivery opportunities for the target market segment over the date range.

14. The advertisement media delivery system as recited in claim 13, wherein the rotation frequency is initialized as a quotient of the delivery goal and an estimated number of display opportunities that will be encountered during the media delivery campaign.

15. The advertisement media delivery system as recited in claim 14, wherein the rotation frequency is dynamically adjusted as a function of the number of actual display opportunities encountered during the media delivery campaign.

16. The advertisement media delivery system as recited in claim 15, wherein the rotation frequency is based on a quotient of the delivery goal and a sum of the number of display opportunities encountered and an estimated number of display opportunities to be encountered for any remaining time in the media delivery campaign.

17. The advertisement media delivery system as recited in claim 16, wherein the advertisement scheduler maintains a dynamic array having a number of array elements representative of fixed periods of time, wherein the sum of time represented by the array elements is equal to the a total time period allotted for the media delivery campaign.

18. The advertisement media delivery system as recited in claim 17, wherein each array element is initially populated with an estimated number of display opportunities to be encountered and wherein the contents of each array element is subsequently replaced with an actual number of display opportunities encountered during the media delivery campaign.

19. A method for tracking media display opportunities in a dynamic array, wherein the dynamic array includes a number of array elements, the method comprising:
obtaining a media delivery campaign including a media delivery goal, a target market segment, and data indicative of a time period for generating the delivery goal;
selecting a number of array elements for the dynamic array, wherein each array element corresponds to a fixed time period and wherein the sum of the array element time periods equal the time period for generating the delivery goal;
populating each array element with an estimated number of display opportunities for the time period represented by array element; and
dynamically replacing the estimated number of display opportunities with an actual number of media display opportunities encountered.

20. The method as recited in claim 19, wherein each array element corresponds to an equal fixed time period.

21. The method as recited in claim 19 further comprising determining a dynamic rotational frequency based upon a quotient of the delivery goal and sum of the dynamic array.

22. The method as recited in claim 19, wherein the media is advertising media to be delivered during an advertisement media campaign.

23. A computer-readable medium having computer-executable instructions for performing the method recited in any one of claims 19-22.

24. A computer system having a processor, a memory and an operating environment, the computer system operable for performing the method recited in any one of claims 19-22.
